(19) United States
(12) Patent Application Publication
(10) Pub. No.: US 2025/0211910 A1
(43) Pub. Date: Jun. 26, 2025

(54) SOUND DEVICE

(71) Applicant: AAC Microtech (Changzhou) Co., Ltd., Changzhou City, Jiangsu Province (CN)

(72) Inventors: Zhang Ren, Shenzhen (CN); Zhiwei Zhong, Shenzhen (CN); Qi Wang, Shenzhen (CN)

(21) Appl. No.: 17/913,834

(22) PCT Filed: Aug. 25, 2022
(86) PCT No.: PCT/CN2022/114903

§ 371 Date: Mar. 17, 2025

(30) Foreign Application Priority Data
Jun. 30, 2022 (CN) 202221696690.5

(51) Int. Cl. H04R 9/02; H04R 7/16; H04R 9/04; H04R 9/06

(52) U.S. Cl. CPC H04R 9/025; H04R 7/16; H04R 9/046; H04R 9/06; H04R 2400/11

(57) ABSTRACT

A sound device is provided, including a frame, a vibration system, and a magnetic circuit system. The magnetic circuit system includes a magnetic yoke and a magnet assembly. The vibration system includes a vibrating diaphragm and a voice coil. The voice coil includes a pair of long axis edges and a pair of short axis edges. The magnet assembly includes a primary magnet and secondary magnets. The primary magnet is fixed on the magnetic yoke. The secondary magnets are disposed around the primary magnet. The secondary magnets and the primary magnet are disposed at intervals to form the magnetic gaps. The secondary magnet includes two first secondary magnets and two second secondary magnets. Compared with related art, the magnetic circuit system of the sound device has better magnetic force.

### TECHNICAL FIELD

The present disclosure relates to a field of electroacoustic conversion, and in particular to a sound device for electronic sound box products.

### BACKGROUND

Sound devices are further known as speakers or loudspeakers and are applied to sound boxes for converting audio signals into sound for playing.

In the related art, the sound devices include an annular frame, a vibration system, and a magnetic circuit system. The vibration system is fixed on the frame, and the magnetic circuit system is configured to drive the vibration system to vibrate and generate sound. The magnetic circuit system includes a magnetic yoke and a magnet assembly, the magnetic yoke is fixed on the frame, and the magnet assembly is accommodated and fixed in the magnetic yoke. The magnetic yoke and the magnet assembly are disposed at intervals to form magnetic gaps. The magnet assembly includes a primary magnet and a secondary magnet, and the secondary magnet surrounds the primary magnet. The secondary magnet is in a hollow annular structure, a cost of which is high, and there is a problem that high-grade magnets may be easily broken when magnetizing.

Therefore, it is necessary to provide a new sound device to solve above technical problems.

### SUMMARY

The present disclosure aims to provide a sound device having better stability.

In order to achieve above aims, the present disclosure provides the sound device, including a frame, a vibration system, and a magnetic circuit system. The vibration system is fixed on the frame. The magnetic circuit system is configured to drive the vibration system to vibrate and generate sound. The magnetic circuit system includes a magnetic yoke and a magnet assembly. The magnetic yoke is fixed on the frame. The magnet assembly is fixed on the magnetic yoke. The magnet assembly includes magnetic gaps. The vibration system includes a vibrating diaphragm and a voice coil. The voice coil is inserted into the magnetic gaps to drive the vibrating diaphragm to vibrate and generate sound. The voice coil includes a pair of long axis edges and a pair of short axis edges. The magnet assembly includes a primary magnet and secondary magnets. The primary magnet is fixed on the magnetic yoke. The secondary magnets are disposed around the primary magnet. The secondary magnets and the primary magnet are disposed at intervals to form the magnetic gaps. The secondary magnets include two first secondary magnets and two second secondary magnets. The two first secondary magnets are disposed on two opposite sides of the primary magnet. The two second secondary magnets are disposed on another two opposite sides of the primary magnet. Each of the two second secondary magnets includes a body portion and extension portions. The extension portions extend from the body portion towards the two first secondary magnets. Projections, along an extension direction of the short axis edges of the voice coil, of the extension portions are at least partially located in the voice coil.

Furthermore, the projections, along the extension direction of the short axis edges of the voice coil, of the extension portions are all located in the voice coil.

Furthermore, projections, along an extension direction of the long axis edges of the voice coil, of the two first secondary magnets are all located in the extension portions.

Furthermore, each of the extension portions includes an extension surface, an outer arc surface, and an inner arc surface. The extension surface is opposite to a respective one of the two first secondary magnets. The outer arc surface is connected to a first end of the extension surface and an outer surface of the body portion. The inner arc surface is connected to a second end of the extension surface and an inner surface of the body portion.

Furthermore, a length, along the extension direction of the short axis edges of the voice coil, of the extension surface is greater than a length, along the extension direction of the short axis edges of the voice coil, of each of the two first secondary magnets.

Furthermore, the extension surface abuts against the respective one of the two first secondary magnets.

Furthermore, the outer arc surface of each of the extension portions shares a same plane with an outer surface of a respective portion of the magnetic yoke.

Furthermore, the two first secondary magnets are disposed on two sides of the long axis edges of the voice coil. The two second secondary magnets are disposed on two sides of the short axis edges of the voice coil.

Furthermore, the magnetic circuit system further includes a primary pole core, a secondary pole core, and an upper magnet. The primary pole core is disposed on the primary magnet. The secondary pole core is disposed on the secondary magnets. The upper magnet is disposed on the primary pole core.

Furthermore, the vibrating diaphragm is fixed on the upper magnet.

Compared with the prior art, the present disclosure provides the sound device, the extension portions are disposed on the second secondary magnets, and the projections, along the extension direction of the short axis edges of the voice coil, of the extension portions are at least partially located in the voice coil, which increases an area of the secondary magnets, improves magnetic force (BL) of the magnetic circuit system, and further improves performance of the sound device.

### BRIEF DESCRIPTION OF DRAWINGS

In order to more clearly illustrate technical solutions in embodiments of the present disclosure, drawings required in description of the embodiments are briefly described below. Obviously, the drawings in the following description are merely some embodiments of the present disclosure. For a person of ordinary skill in art, other drawings may be obtained according to the drawings without creative efforts.

FIG. 1 is a three-dimensional structural schematic diagram of a sound device according to one embodiment of the present disclosure.

FIG. 2 is a cross-sectional schematic diagram taken along the line A-A shown in FIG. 1.

FIG. 3 is an exploded schematic diagram of the sound device according to one embodiment of the present disclosure.

FIG. 4 is an exploded schematic diagram of a magnetic circuit system of the sound device according to one embodiment of the present disclosure.

### DETAILED DESCRIPTION OF EMBODIMENTS

Technical solutions in embodiments of the present disclosure are clearly and completely described below with reference to accompanying drawings in the embodiments of the present disclosure. Obviously, the described embodiments are only a part of the embodiments of the present disclosure, not all of the embodiments. Based on the embodiments of the present disclosure, all other embodiments obtained by a person of ordinary skill in art without creative efforts shall fall within a protection scope of the present disclosure.

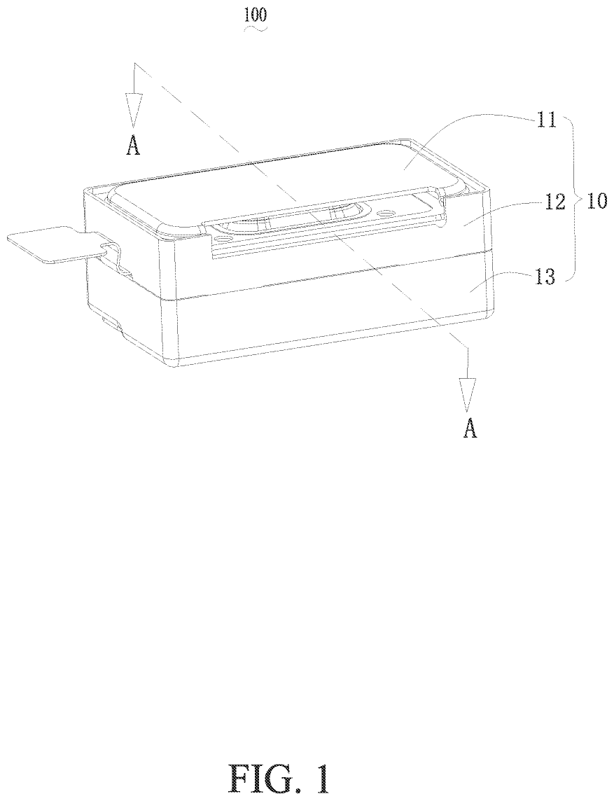

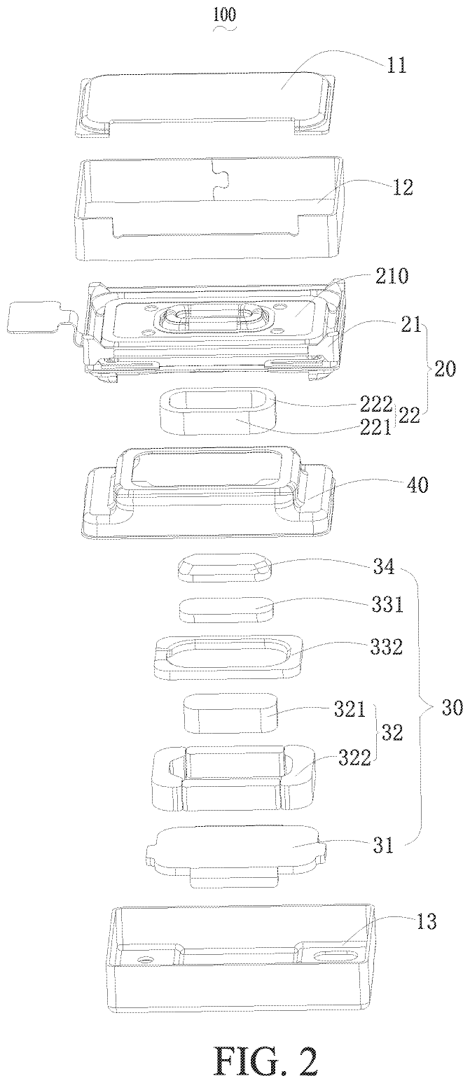

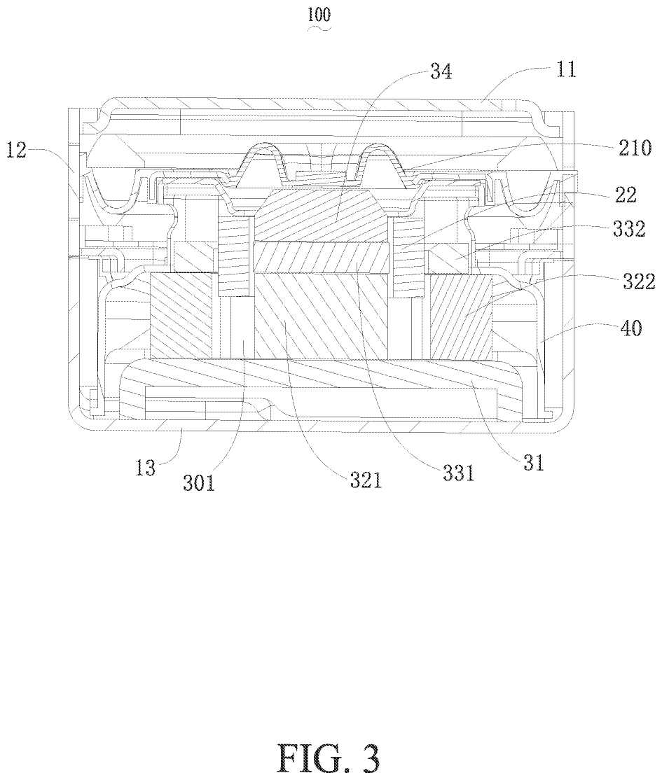

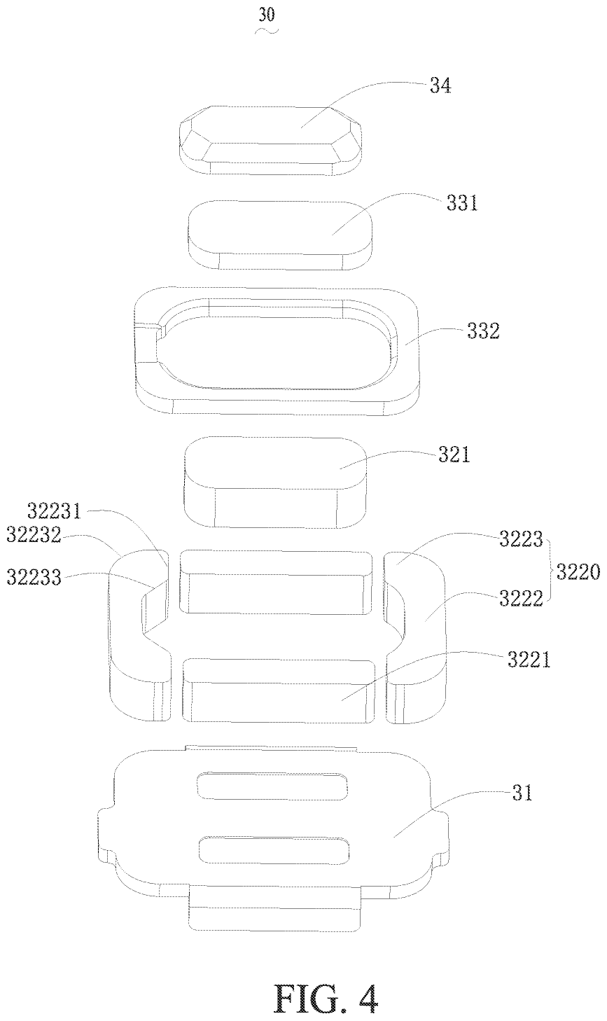

Referring to FIGS. 1-4, the present disclosure provides a sound device 100, including a frame 1, a vibration system 20, and a magnetic circuit system 30. The vibration system 20 is fixed on the frame 1. The magnetic circuit system 30 is configured to drive the vibration system 20 to vibrate and generate sound.

The frame 1 includes an upper cover 11, a lower cover 13, and a middle frame 12, and the middle frame 12 is disposed between the upper cover 11 and the lower cover 13. The upper cover 11, the middle frame 12, and the lower cover 13 are covered together to form a space for accommodating the vibration system 20 and the magnetic circuit system 30.

The vibration system 20 includes a vibration assembly 21 and a voice coil 22. The vibration assembly 21 includes a vibrating diaphragm 210. The voice coil 22 is configured to drive the vibrating diaphragm 210 to vibrate and generate sound. The voice coil 22 is racetrack-shaped and includes a pair of long axis edges 221 and a pair of short axis edges 222.

The magnetic circuit system 30 includes a magnetic yoke 31 and a magnet assembly 32. The magnetic yoke 31 is fixed on the frame 1. The magnet assembly 32 is fixed on the magnetic yoke 31. The magnet assembly 32 includes magnetic gaps 301. The magnet assembly 32 includes a primary magnet 321 and secondary magnets 322. The secondary magnets 322 are disposed around the primary magnet 321. The secondary magnets 322 and the primary magnet 321 are disposed at intervals to form the magnetic gaps 300. The voice coil 22 is inserted into the magnetic gaps 301. The secondary magnets 322 include two first secondary magnets 3221 and two second secondary magnets 3220. The two first secondary magnets 3221 are disposed on two opposite sides of the primary magnet 321. The two second secondary magnets 3220 are disposed on another two opposite sides of the primary magnet 321. In the embodiment, the two first secondary magnets 3221 are respectively disposed on two sides of the long axis edges 221 of the voice coil 22, and the two second secondary magnets 3220 are respectively disposed on two sides of the short axis edges 222 of the voice coil 22.

In the embodiment, each of the two second secondary magnets 3220 includes a body portion 3222 and extension portions 3223. The extension portions 3223 extend from the body portion 3222 towards the first secondary magnets 3221. Projections, along an extension direction of the short axis edges 222 of the voice coil 22, of the extension portions 3223 are at least partially located in the voice coil 22. Therefore, an area of the second secondary magnets 3220 is increased in an original space to improve the magnetic force (BL) of the magnetic circuit system. In the embodiment, the projections, along the extension direction of the short axis edges 222 of the voice coil 22, of the extension portions 3223 are all located in the voice coil 22. In addition, projections, along an extension direction of the long axis edges 221 of the voice coil 22, of the two first secondary magnets 3221 are all located in the extension portions 3223. That is, an extension surface 32231 opposite to a respective one of the two first secondary magnets 3221 is disposed on the extension portion 3223. A length, along the extension direction of the short axis edges 222 of the voice coil 22, of the extension surface 32231 is greater than or equal to a length, along the extension direction of the short axis edges 222 of the voice coil 22, of each of the first secondary magnets 3221, which maximizes the BL under same size conditions. Moreover, the extension surface 32231 may abut against the respective one of the two first secondary magnets 3221, or may be disposed opposite to the first secondary magnets 3221 at intervals.

Furthermore, each of the extension portions 3223 further includes an outer arc surface 32232 and an inner arc surface 32233. The outer arc surface 32232 is connected to a first end of the extension surface 32231 and an outer surface of the body portion 3222. The inner arc surface 32233 is connected to a second end of the extension surface 32231 and an inner surface of the body portion 3222. The outer arc surface 32232 of each of the extension portions 3223 shares a same plane with an outer surface of a respective portion of the magnetic yoke 31. The inner arc surface 32233 is disposed opposite to a corner portion of the voice coil 22.

In addition, the extension portion 3223 is disposed on each of the two second secondary magnets 3220. The extension portion 3223 is disposed at each of two ends of each of the two second secondary magnets 3220. Therefore, the two first secondary magnets 3221 and the two second secondary magnets 3220 are disposed around the voice coil 22, which maximizes an area of the secondary magnets 322, and further increases the BL.

The magnetic circuit system 30 further includes a primary pole core 331, a secondary pole core 332, and an upper magnet 34. The primary pole core 331 is disposed on the primary magnet 321. The secondary pole core 332 is disposed on the secondary magnets 322. The upper magnet 34 is disposed on the primary pole core 331. The secondary pole core 332 is in a hollow annular structure. The vibrating diaphragm 210 is fixed on the upper magnet 34. The upper magnet 34 not only fixes and supports the vibrating diaphragm 210, but also improves the BL.

In the embodiment, the sound device 100 further includes a breathable spacer 40. A first end of the breathable spacer 40 is fixed to the second secondary magnets 3220, and a second end of the breathable spacer 40 is fixed to the lower cover 13.

In the embodiment, the extension portions 3223 are disposed on the second secondary magnets 3220, and the projections, along the extension direction of the short axis edges 222 of the voice coil 22, of the extension portions 3223 are at least partially located in the voice coil 22, which increases an area of the secondary magnets 322, improves the magnetic force (BL) of the magnetic circuit system 30, and further improves performance of the sound device 100.

The above are only the embodiments of the present disclosure. It should be noted that, for the person of ordinary skill in the art, improvements are made without departing from concepts of the present disclosure, but these are all within the protection scope of the present disclosure.

### SUMMARY

### Technical Problem

[symbol]

### Solutions for the Technical Problem

[symbol]

### Beneficial Effects of the Present Disclosure

[symbol]

What is claimed is:

1. A sound device, comprising:
a frame;
a vibration system; and
a magnetic circuit system;
wherein the vibration system is fixed on the frame, and the magnetic circuit system is configured to drive the vibration system to vibrate and generate sound; the magnetic circuit system comprises a magnetic yoke and a magnet assembly, the magnetic yoke is fixed on the frame, the magnet assembly is fixed on the magnetic yoke, and the magnet assembly comprises magnetic gaps; the vibration system comprises a vibrating diaphragm and a voice coil, the voice coil is inserted into the magnetic gaps to drive the vibrating diaphragm to vibrate and generate sound; the voice coil comprises a pair of long axis edges and a pair of short axis edges, the magnet assembly comprises a primary magnet and secondary magnets, the primary magnet is fixed on the magnetic yoke, the secondary magnets are disposed around the primary magnet, the secondary magnets and the primary magnet are disposed at intervals to form the magnetic gaps, the secondary magnets comprise two first secondary magnets and two second secondary magnets, the two first secondary magnets are disposed on two opposite sides of the primary magnet, the two second secondary magnets are disposed on another two opposite sides of the primary magnet; each of the two second secondary magnets comprises a body portion and extension portions, the extension portions extend from the body portion to the two first secondary magnets; and projections, along an extension direction of the short axis edges of the voice coil, of the extension portions are at least partially located in the voice coil.

2. The sound device according to claim 1, wherein the projections, along the extension direction of the short axis edges of the voice coil, of the extension portions are all located in the voice coil.

3. The sound device according to claim 1, wherein projections, along an extension direction of the long axis edges of the voice coil, of the two first secondary magnets are all located in the extension portions.

4. The sound device according to claim 1, wherein each of the extension portions comprises an extension surface, an outer arc surface, and an inner arc surface; the extension surface is opposite to a respective one of the two first secondary magnets, the outer arc surface is connected to a first end of the extension surface and an outer surface of the body portion, and the inner arc surface is connected to a second end of the extension surface and an inner surface of the body portion.

5. The sound device according to claim 4, wherein a length, along the extension direction of the short axis edges of the voice coil, of the extension surface, is greater than a length, along the extension direction of the short axis edges of the voice coil, of each of the two first secondary magnets.

6. The sound device according to claim 5, wherein the extension surface abuts against the respective one of the two first secondary magnets.

7. The sound device according to claim 4, wherein the outer arc surface of each of the extension portions shares a same plane with an outer surface of a respective portion of the magnetic yoke.

8. The sound device according to claim 1, wherein the two first secondary magnets are disposed on two sides of the long axis edges of the voice coil, and the two second secondary magnets are disposed on two sides of the short axis edges of the voice coil.

9. The sound device according to claim 1, wherein the magnetic circuit system further comprises a primary pole core, a secondary pole core, and an upper magnet; the primary pole core is disposed on the primary magnet, the secondary pole core is disposed on the secondary magnets, and the upper magnet is disposed on the primary pole core.

10. The sound device according to claim 9, wherein the vibrating diaphragm is fixed on the upper magnet.
